(19) United States
(12) Patent Application Publication
(10) Pub. No.: US 2019/0076873 A1
(43) Pub. Date: Mar. 14, 2019

(54) MANUFACTURING METHOD FOR INTERMEDIATE TRANSFER BELT AND MANUFACTURING DEVICE FOR INTERMEDIATE TRANSFER BELT

(71) Applicant: Konica Minolta, Inc., Tokyo (JP)

(72) Inventors: Tsuyoshi SHIMODA, Tokyo (JP); Junji UJIHARA, Tokyo (JP); Takayuki SUZUKI, Niiza-shi (JP)

(21) Appl. No.: 16/115,080

(22) Filed: Aug. 28, 2018

(30) Foreign Application Priority Data
Sep. 8, 2017 (JP) 2017-172659

(51) Int. Cl. B05D 1/02; G03G 15/16

(52) U.S. Cl. CPC B05D 1/02; G03G 15/162

(57) ABSTRACT

A manufacturing method for an intermediate transfer belt to manufacture an intermediate transfer belt including at least a base material and a surface layer, includes: forming a surface layer by applying application liquid to an outer peripheral surface of the base material by using a plurality of nozzles while the base material is being rotated, the application liquid having a viscosity within a range of 0.5 to 10 mPa·s at 20° C., wherein, as for the nozzles used in the surface layer forming step, a flow rate per nozzle is set within a range of 3 to 10 mL/min, and a ratio value (m/L) between a nozzle inner diameter (m) and a center-to-center distance between nozzles (L) is set in a range of 0.05 to 0.10.

The entire disclosure of Japanese patent Application No. 2017-172659, filed on Sep. 8, 2017, is incorporated herein by reference in its entirety.

### BACKGROUND

### Technological Field

The present invention relates to a manufacturing method for an intermediate transfer belt and a manufacturing device for an intermediate transfer belt, and particularly relates to a manufacturing method for an intermediate transfer belt and the like in which a seamless uniform film (having no pitch irregularity) can be formed and also a favorable cleaning property can be ensured.

### Description of the Related Art

In the related art, there is a known thin film application method using low-viscosity application liquid, in which a thin film is formed by using a spray or a dispenser (nozzle). Spray application is the most used application method, but since liquid droplets are discharged, there are restrictions in solvent and application efficiency is not so favorable, and therefore, the spray application is not suitable considering productivity.

On the other hand, high-viscosity liquid is used in dispenser (nozzle) application. Specifically, there is a known technique in which high-viscosity liquid is applied to an outer peripheral surface of a cylindrical core body by using a large number of nozzles from a twin-screw pump while the core body is rotated (refer to, for example, JP 2007-152205 A).

In this technique, a seam (pitch regularity) is generated when application liquid discharged from a nozzle impacts on a base material and wetly spreads while the core body is rotated, and then becomes continuous with application liquid that impacts next on the base material. Therefore, a uniform film is formed by performing leveling with a loop blade or a spatula concurrently with liquid application.

However, in a case of forming a thin film by using low-viscosity application liquid, it is difficult to adjust the film by using such a loop blade or spatula as described above because the applied film is thin.

### SUMMARY

The present invention has been made to solve above-describe problems and circumstances, and the object is to provide a manufacturing method for an intermediate transfer belt and a manufacturing device for an intermediate transfer belt, in which a seamless uniform film (having no pitch irregularity) can be formed in film formation using low-viscosity application liquid and also a favorable cleaning property can be ensured.

To achieve the abovementioned object, according to an aspect of the present invention, a manufacturing method for an intermediate transfer belt to manufacture an intermediate transfer belt including at least a base material and a surface layer, reflecting one aspect of the present invention comprises:

forming a surface layer by applying application liquid to an outer peripheral surface of the base material by using a plurality of nozzles while the base material is being rotated, the application liquid having a viscosity within a range of 0.5 to 10 mPa·s at 20° C.,

wherein, as for the nozzles used in the surface layer forming step, a flow rate per nozzle is set within a range of 3 to 10 mL/min, and a ratio value (m/L) between a nozzle inner diameter (m) and a center-to-center distance between nozzles (L) is set in a range of 0.05 to 0.10.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1A is a schematic side view illustrating nozzles according to the present embodiment;

FIG. 1B is a bottom view of the nozzle according to the present embodiment;

FIG. 2 is a schematic view illustrating a part of a manufacturing device for an intermediate transfer belt according to the present embodiment;

FIG. 3 is a schematic view illustrating a part of the manufacturing device for an intermediate transfer belt according to the present embodiment; and

FIG. 4 is a schematic view illustrating a part of the manufacturing device for an intermediate transfer belt according to the present embodiment.

### DETAILED DESCRIPTION OF EMBODIMENTS

Hereinafter, one or more embodiments of the present invention will be described with reference to the drawings. However, the scope of the invention is not limited to the disclosed embodiments.

A manufacturing method for an intermediate transfer belt according to the present invention is a manufacturing method for an intermediate transfer belt to manufacture an intermediate transfer belt including at least a base material and a surface layer, and characterized in including a step of forming a surface layer by applying application liquid to an outer peripheral surface of the base material by using a plurality of nozzles while the base material is being rotated, and the application liquid has a viscosity within a range of 0.5 to 10 mPa·s at 20° C. The nozzles used in the surface layer forming step are characterized in that a flow rate per nozzle is set within a range of 3 to 10 mL/min, and a ratio value (m/L) between a nozzle inner diameter (m) and a center-to-center distance between nozzles (L) is set within a range of 0.05 to 0.10. The above characteristics are technical features common or correspondent in the invention according to the present embodiment.

As an aspect of the present invention, it is preferable that the surface layer be formed on the outer peripheral surface of the base material by using the plurality of nozzles while the base material is held and rotated by a plurality of rollers from the viewpoints that: the base material can be rotated while applying tension to the base material with the plurality of rollers; and the application liquid can be surely discharged to the outer peripheral surface of the base material.

It is preferable that the surface layer have a thickness within a range of 2.0 to 8.0 μm from the viewpoints of breakage and cracking on an outermost surface.

It is preferable that the surface layer contain a photocurable resin from the viewpoints of mechanical strength and a transfer rate.

It is preferable that the surface layer contain a thermosetting resin from the viewpoint of bendabilty in bending.

As for the base material, a polyphenylene sulfide resin is preferable in the viewpoint of cost saving, and a polyimide resin or a polyamideimide resin is preferable from the viewpoint of mechanical strength.

A manufacturing device for an intermediate transfer belt of the present invention is suitably used in the manufacturing method for an intermediate transfer belt of the present invention.

In the following, the present invention, constituent elements thereof, and modes and aspects to implement the present invention will be described in detail. Note that, in the present application, the term “to” is used as a meaning to include, as a lower limit value and an upper limit value, numerical values specified before and after the “to”.

[Overview of Manufacturing Method for Intermediate Transfer Belt of Present Invention]

A manufacturing method for an intermediate transfer belt according to the present invention is a manufacturing method for an intermediate transfer belt to manufacture an intermediate transfer belt including at least a base material and a surface layer, and the method includes a step of forming a surface layer by applying application liquid to an outer peripheral surface of the base material by using a plurality of nozzles while the base material is rotated (hereinafter also referred to as “surface layer forming step”), and the application liquid has a viscosity of 0.5 to 10 mPa·s at 20° C.

Additionally, as for the nozzles used in the step, a flow rate per nozzle is set within a range of 3 to 10 mL/min, and a ratio value (m/L) between a nozzle inner diameter (m) and a center-to-center distance between adjacent nozzles (L) is set within a range of 0.05 to 0.10.

First, a structure of the intermediate transfer belt according to the present invention will be described.

[Structure of Intermediate Transfer Belt]

The intermediate transfer belt according to the present invention has at least a base material and a surface layer provided on the base material.

<Base Material>

The base material preferably has an endless belt shape.

The base material may be formed by, for example, dissolving a resin composition containing a crystalline resin into a known solvent and drying the same, or may be formed by heating and kneading a resin composition containing a crystalline resin and shaping the same by a molding method such as an extrusion molding method or an inflation molding method.

Examples of the crystalline resin include polyphenylene sulfide, polycarbonate, polyvinylidene fluoride, polyalkylene terephthalate such as polyethylene terephthalate and polybutylene terephthalate, polyether, polyether ketone, polyarylate, polysulfone, polyethersulfone, polyetherimide, polyimide, polyamideimide, and polyether ether ketone. Among these resins, polyphenylene sulfide, polyimide, polyamideimide, and polystyrene are preferable, and polyphenylene sulfide is particularly preferable.

The number of kinds of these crystalline resins constituting the base material may be one kind or more.

Additionally, carbon nanofibers may also be contained in the base material.

Details of the above-described polyimide, polyamideimide, and carbon nanofibers can be adopted with reference to paragraphs [0021] to [0072] of Japanese Patent No. 6155847, for example.

The base material may further contain components other than the crystalline resin as necessary. Examples of components other than the crystalline resin include a conductive filler, a lubricant, and a stabilizer.

Examples of the conductive filler include carbon black.

The carbon black is, for example, neutral carbon black. An adding amount of the conductive filler is preferably within a range of 10 to 20 parts by mass, and more preferably, within a range of 10 to 16 parts by mass with respect to 100 parts by mass of the crystalline resin.

Examples of the lubricant include aliphatic hydrocarbons such as a paraffin wax and a polyolefin wax; higher fatty acids such as a lauric acid, a myristic acid, a palmitic acid, a stearic acid, and a behenic acid; and higher fatty acid metal salts such as a sodium salt, a lithium salt, and a calcium salt of the higher fatty acids. The number of kinds of the lubricant may be one kind or more.

A contained amount of the lubricant is preferably within a range of 0.1 to 0.5 parts by mass, and more preferably, within a range of 0.1 to 0.3 parts by mass with respect to 100 mass % of the crystalline resin.

Examples of the stabilizer include a phenol series antioxidant, an amine series antioxidant, a hydroquinone series antioxidant, a sulfur series antioxidant, and a phosphoric acid series antioxidant. The number of kinds of the stabilizer may be one kind or more. A contained amount of the stabilizer is preferably within a range of 2 to 10 parts by mass, and more preferably, within a range of 2 to 5 parts by mass with respect to 100 mass % of the crystalline resin.

<Surface Layer>

The surface layer is formed by applying a surface layer application liquid to the outer peripheral surface of the base material while the base material is rotated.

The surface layer preferably contains a photocurable resin or a thermosetting resin.

(Photocurable Resin)

As a polymerizable component to form a photocurable resin, a polyfunctional (meth)acrylate or a polymerizable compound having a low surface energy group other than the polyfunctional (meth)acrylate, or the like can be contained, and it is preferable to contain the polyfunctional (meth)acrylate.

The polyfunctional (meth)acrylate has two or more (meth)acryloyloxy groups in one molecule and is used to develop abrasion resistance, tenacity, and adhesion of the surface layer of the intermediate transfer belt. Specific examples thereof include: bifunctional monomers such as bis(2-acryloxyethyl)-hydroxyethyl-isocyanurate, 1,6-hexanediol diacrylate, 1,4-butanediol diacrylate, 1,9-nomanediol diacrylate, neopentyl glycol diacrylate, hydroxypivalic acid neopentyl glycol diacrylate, and urethane acrylate; and polyfunctional monomers having three or more functions, such as trimethylolpropane triacrylate (TMPTA), pentaerythritol triacrylate, tris(acryloxyethyl) isocyanurate, ditrimethylolpropane tetraacrylate, pentaerythritol tetraacrylate (PETA), dipentaerythritol hexaacrylate (DPHA), urethane acrylate, and an ester compound obtained by combination of polyhydric alcohol, a polybasic acid, and a (meth)acrylic acid, for example, an ester compound obtained by combination of trimethylol ethane/succinic acid/acrylic acid=2/1/4.

To impart a hard coating property to the applied film, it is preferable to use trifunctional or higher functional acrylate.

The polyfunctional (meth)acrylate is preferably contained in the polymerizable component in a proportion of 20 to 90 mass/%.

As for the polymerizable compound having a low surface energy group, the low surface energy group represents a functional group having a function to reduce surface free energy of the surface layer, and specifically, represents an acrylate group modified with silicone or modified with fluorine.

Examples of a silicone-modified site include dimethylpolysiloxane, methyl hydrogen polysiloxane, and the like, and examples of a fluorine-modified site include polytetrafluoroethylene (PTFE), tetrafluoroethylene-perfluoroalkylvinylether polymer (PFA), and the like.

As for the above-described photocurable resin obtained by curing the polymerizable component by polymerization reaction, a content ratio of a structural unit derived from the polyfunctional (meth)acrylate is preferably within a range of 20 to 90 mass/%.

Additionally, examples of a photopolymerization initiator include benzophenone, Michler's ketone, 1-hydroxycyclohexyl-phenyl ketone, thioxanthone, benzobutyl ether, acyloxime ester, dibenzosurobene, and bisacylphosphine oxide.

An adding amount of the photopolymerization initiator is preferably within a range of 0.1 to 30 parts by mass, and more preferably, within a range of 0.5 to 10 parts by mass with respect to 100 parts by mass of the photopolymerizable monomer.

(Thermosetting Resin)

Examples of the thermosetting resin contained in the surface layer include a silicone resin, a phenoxy resin, a polysulfone resin, a polyvinyl butyral resin, a polyvinyl formal resin, a polyester resin, a cellulose ester resin, an urethane resin, a phenol resin, an epoxy resin, a polycarbonate resin, a polyarylate resin, a polyamide resin, a polyimide resin, a melamine resin, an alkyd resin, and the like.

(Metal Oxide Fine Particles)

Preferably, the surface layer contains metal oxide fine particles subjected to surface treatment.

Since the surface layer contains metal oxide fine particles, tenacity can be obtained in the surface layer, and high durability is obtained.

An untreated metal oxide fine particle is to be at least a metal oxide including also a transition metal, and examples thereof include a silica (silicon oxide), a magnesium oxide, a zinc oxide, a lead oxide, an aluminum oxide, a tantalum oxide, an indium oxide, a bismuth oxide, a yttrium oxide, a cobalt oxide, a copper oxide, a manganese oxide, a selenium oxide, an iron oxide, a zirconium oxide, a germanium oxide, a tin oxide, a titanium oxide, a niobium oxide, molybdenum oxide, and a vanadium oxide. Among the examples, the titanium oxide, aluminum oxide, zinc oxide, tin oxide, and the like are preferable, and particularly, the aluminum oxide and tin oxide are preferable.

Examples of a surface treatment agent used for surface treatment for the untreated metal oxide fine particle include a compound containing a radical polymerizable functional group. Examples of the radical polymerizable functional group include an acryloyl group and a methacryloyl group.

(Solvent)

Examples of the solvent used for the surface layer application liquid include n-butyl alcohol, isopropyl alcohol, ethyl alcohol, methyl alcohol, methyl isobutyl ketone, and methyl ethyl ketone.

The surface layer preferably has a thickness within a range of 2.0 to 8.0 μm. The reason is that: in a case where the thickness of the surface layer is 2.0 μm or more, mechanical strength is sufficient, and a filler contained in the surface layer is sufficient and a transfer rate is improved. In a case where the thickness of the surface layer is 8.0 μm or less, bendabilty of an intermediate transfer belt is prevented from being degraded.

The thickness of the surface layer can be measured by a known method and can be adjusted by the number of times of applying the surface layer application liquid.

For example, the thickness of the surface layer can be obtained as a measured value or an average value thereof obtained from a cross-section at the time of cutting the intermediate transfer belt in a layered direction.

[Manufacturing Method for Intermediate Transfer Belt]

The manufacturing method for an intermediate transfer belt of the present invention includes a step of forming a surface layer by applying application liquid to an outer peripheral surface of a base material by using a plurality of nozzles while the base material is rotated (hereinafter also referred to as “surface layer forming step”), and the application liquid has a viscosity within a range of 0.5 to 10 mPa·s at 20° C.

<Surface Layer Forming Step>

The surface layer forming step includes a step to prepare a base material and surface layer application liquid according to the present invention (preparation step) and a step to apply the surface layer application liquid (application step), and it is preferable to further include a step to irradiate, with actinic rays, an applied film formed from the surface layer application liquid (actinic ray irradiation step) or a step to thermally heat the applied film (thermal curing step).

(Preparation Step)

As for the base material and the surface layer application liquid, those described above can be used.

The surface layer application liquid is characterized in having the viscosity within the range of 0.5 to 10 mPa·s at 20° C. Setting the viscosity within the above range is preferable in a point that a thin film can be more suitably formed by using the nozzles according to the present invention. Furthermore, setting the viscosity within the range of 0.5 to 5.0 mPa·s at 20° C. is preferable in a point that a more uniform film can be formed.

A means to adjust the viscosity as described above can be achieved by suitably selecting the above-describe resins, metal oxide particles, solvent, and the like.

(Application Step)

The number of nozzles used in the application step is at least two or more, and having two to five nozzles is preferable in a point that a uniform film can be formed.

These nozzles are respectively arranged above one end side in an advancing direction of the base material and along a width direction of the base material (rotation axis direction of a roller or a rotating body described later). Then, each of the nozzles reciprocates in parallel along the width direction of the base material.

Setting a travel speed of the nozzle within a range of 8.0 to 10.0 mm/sec is preferable in a point that a seamless uniform film can be formed.

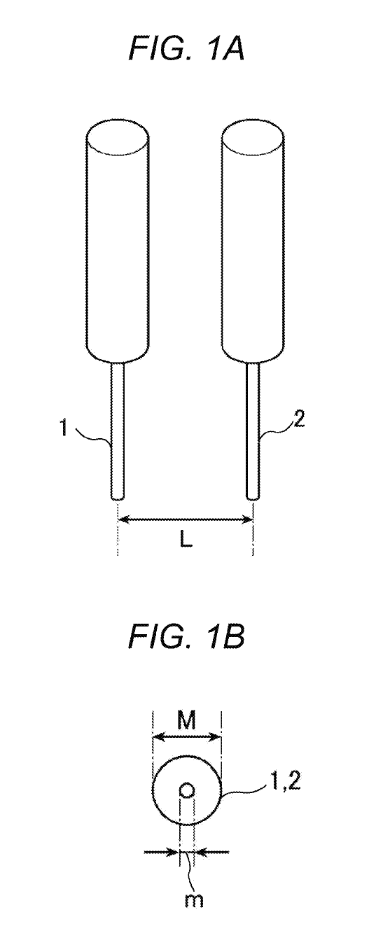

As illustrated in FIGS. 1A and 1B, setting each of the nozzles 1 and 2 to have an inner diameter m within a range of 0.2 to 0.4 mm and setting each of the nozzles 1 and 2 to have an outer diameter M within a range of 1.0 to 1.2 mm are preferable in the points of liquid dropping and liquid sucking.

Here, the inner diameter m of each of the nozzles 1 and 2 is to be a wetly spreading width of the application liquid discharged from the nozzles 1 and 2, and a center-to-center distance between nozzles L is determined in accordance with the wetly spreading width. In a case where the center-to-center distance between nozzles L is too close, the application liquid discharged from one nozzle 1 overlaps with the application liquid discharged from the other nozzle 2 adjacent to the nozzle 1, and in contrast, in a case where the center-to-center distance between nozzles L is too far, a seam is formed because the application liquid from the nozzle 1 does not become continuous with the application liquid from the nozzle 2. Therefore, it is preferable that a ratio value (m/L) between the inner diameter m of each of the nozzles 1 and 2 and the center-to-center distance between nozzles L be within a following range.

In the present invention, the ratio value (m/L) between the nozzle inner diameter (m) and the center-to-center distance between the adjacent nozzles (L) is characterized in setting within the range of 0.05 to 0.10.

By thus setting the ratio value (m/L) between the nozzle inner diameter m and the center-to-center distance between nozzles L within the above range, and it is possible to shorten, without changing a rotation speed of the base material, a period from when the application liquid discharged from each of the nozzles 1 and 2 impacts on the base material and wetly spreads on the base material while the base material is rotated until the application liquid becomes continuous with next application liquid discharged from each of the nozzles and impacting on the base material, and a seamless uniform thin film can be formed.

Also, a flow rate per nozzle is characterized in being within a range of 3 to 10 mL/min. More preferably, the flow rate is within a range of 3.0 to 5.0 mL/min.

Meanwhile, details of the nozzle will be described in a description of the manufacturing device for an intermediate transfer belt described later.

As a means to rotate the base material, a plurality of rollers or a cylindrical rotating body, or the like described later can be exemplified. A rotation driving device is connected to the plurality of rollers or the cylindrical rotating body.

In a case of using the plurality of rollers, the rollers are arranged at both ends of the base material that is an endless belt, and hold the base material while applying tension thereto, and also can rotate the base material in accordance with rotation of the rollers.

Additionally, in a case of using the cylindrical rotating body, the base material that is the endless belt is arranged on an outer peripheral surface of the rotating body, and the base material can be rotated in accordance with rotational motion of the rotating body.

It is preferable that the surface layer is formed to have the thickness within the range of 2.0 to 8.0 μm from the viewpoint of improving mechanical strength and transferability.

(Actinic Ray Irradiation Step)

In a case where a photocurable resin is contained in the surface layer application liquid, the applied film on the base material is irradiated with actinic rays.

The applied film is irradiated with the actinic rays in order to form a surface layer by photopolymerizing the photopolymerizable monomer. At this point, since the applied film is irradiated with the actinic rays while the base material is rotated, temperature increase of the base material is suppressed, and the photopolymerizable monomer can be photopolymerized while suppressing change of crystallinity of the base material. Irradiation energy of the actinic rays, the number of times of irradiation, an irradiation period, and the like can be suitably set in accordance with output of a light source, a kind of photopolymerizable monomer, and the like.

It is preferable that an irradiation amount with the actinic rays be 100 mJ/cm² or more, more preferably, within a range of 120 to 200 mJ/cm², and more preferably, within a range of 150 to 180 mJ/cm² from the viewpoints of curing unevenness, hardness, a curing time, a curing rate, and the like of the applied film. The irradiation amount can be measured by, for example, UIT250 (manufactured by Ushio Inc.). It is preferable that the applied film be irradiated with ultraviolet from a UV-LED light source device from the viewpoint of reducing heat supplied to the base material.

It is preferable that the irradiation period of the actinic rays be from 0.5 seconds to 5 minutes, and more preferably, from 3 seconds to 2 minutes from the viewpoints of curing efficiency, working efficiency, and the like for the applied film.

It is preferable that an oxygen concentration in atmosphere at the time of irradiating the applied film with actinic rays be 5% or less, and more preferably, 1% or less from the viewpoints of curing unevenness and a curing time (curing efficiency) and the like of the applied film. The oxygen concentration can be adjusted by, for example, introducing a nitrogen gas into the atmosphere by a purge device. The above oxygen concentration can be measured by, for example, an atmospheric gas management oxygen concentration meter “OX 100” (manufactured by Yokogawa Electric Corporation).

(Thermosetting Step)

In a case where a thermosetting resin is included in the surface layer application liquid, the applied film on the base material is thermally cured by a drying device.

[Manufacturing Device for Intermediate Transfer Belt of Present Invention]

<Structure of Manufacturing Device>

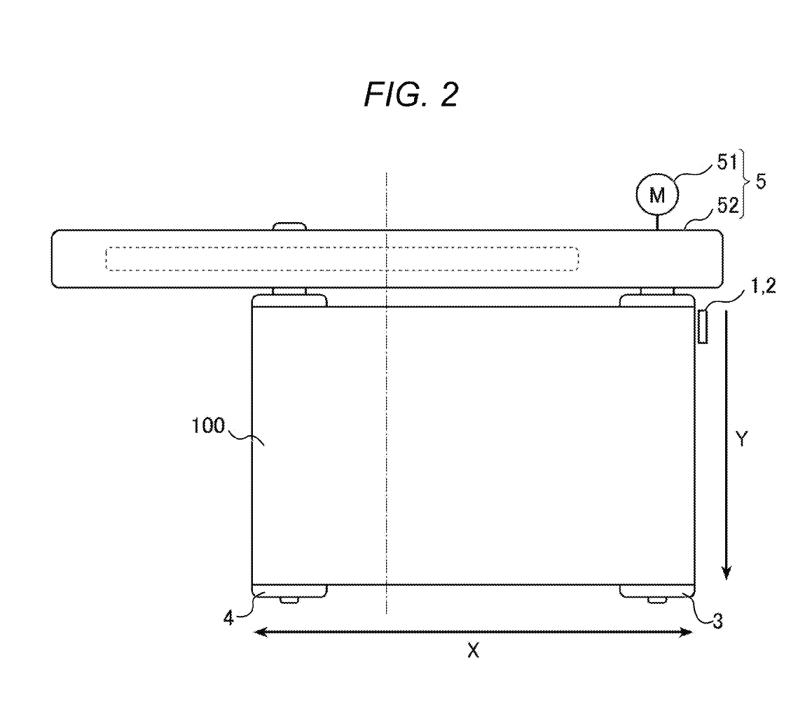

FIGS. 2 to 4 are schematic views each illustrating a part of a manufacturing device for an intermediate transfer belt according to the present embodiment. The manufacturing device for an intermediate transfer belt according to the present embodiment (hereinafter also simply referred to as “manufacturing device”) is a device to manufacture an intermediate transfer belt including at least a base material and a surface layer.

As illustrated in FIGS. 2 to 4, the manufacturing device includes a plurality of nozzles 1 and 2, a plurality of rollers 3 and 4, and a rotation driving device 5, and includes an actinic ray beam irradiation device 6 or a drying device 7. Additionally, a purge device (not illustrated) is provided as necessary.

The plurality of nozzles 1 and 2 applies surface layer application liquid to an outer peripheral surface of a base material 100. In the present embodiment, the device is provided with the two nozzles 1 and 2.

The two nozzles 1 and 2 are disposed above one end side in an advancing direction X of the base material 100 and along a width direction Y of the base material 100 (direction of rotation axes of the rollers 3 and 4) respectively.

Specifically, each of the two nozzles 1 and 2 are supported by a rail or the like (not illustrated) and reciprocates in parallel in the width direction Y of the base material 100 by being driven by a driving unit (not illustrated). In other words, the nozzles 1 and 2 travel in the direction Y orthogonal to the advancing direction X by rotation of the base material 100.

The travel speed of each of the nozzles 1 and 2, the flow rate per nozzle, the inner diameter m and the outer diameter M of each of the nozzles 1 and 2, and the nozzle inner diameter m/a center-to-center distance between nozzles L are as described above, and therefore, the description thereof will be omitted here.

The plurality of rollers 3 and 4 is respectively disposed at both ends of the base material 100 that is the endless belt, and holds and supports the base material 100 in a rotatable manner. At least one of the plurality of rollers 3 and 4 is connected to the rotation driving device 5.

The number of the rollers 3 and 4 is two in the present embodiment, one roller 3 is connected to the rotation driving device 5 and rotated to function as a driving roller 3, and the base material 100 is rotated in accordance with rotational motion of the driving roller 3.

The other roller 4 is made to function as a driven roller 4 that is rotated in accordance with rotational movement of the base material 100.

Each of the rollers 3 and 4 preferably have an outer diameter within a range of 60 to 120 mm. Within this range, bendabilty at portions of the base material 100 on the rollers is increased at time of manufacturing the intermediate transfer belt, and creep is hardly caused. The respective rollers may have the same outer diameter or may have different outer diameters. In the present embodiment, the two rollers 3 and 4 have the same outer diameter.

A rotation speed of each of the rollers 3 and 4 is preferably within a range of 750 to 1500 mm/sec.

Additionally, setting the base material 100 to have a length (length in the advancing direction X) within a range of 250 to 500 mm and setting the base material 100 to have a width (length in the width direction Y) within a range of 300 to 500 mm are preferable in points of run-out precision during belt rotation and meandering.

The rotary driving device 5 transmits power to at least one of the rollers 3 and 4 to rotationally drive at least one of the rollers 3 and 4. With this power driving, the manufacturing device according to the present embodiment can move, on an endless track, the base material 100 supported by the rollers 3 and 4. The rotation driving device 5 is formed of components such as a motor 51, a gear, and a power transmission belt 52. In the present embodiment, parts such as the motor 51 and the gear are connected to one driving roller 3 via the power transmission belt 52. Additionally, the driven roller 4 not connected to the rotation driving device 5 is rotated by following rotation of the driving roller 3 connected to the rotation driving device 5.

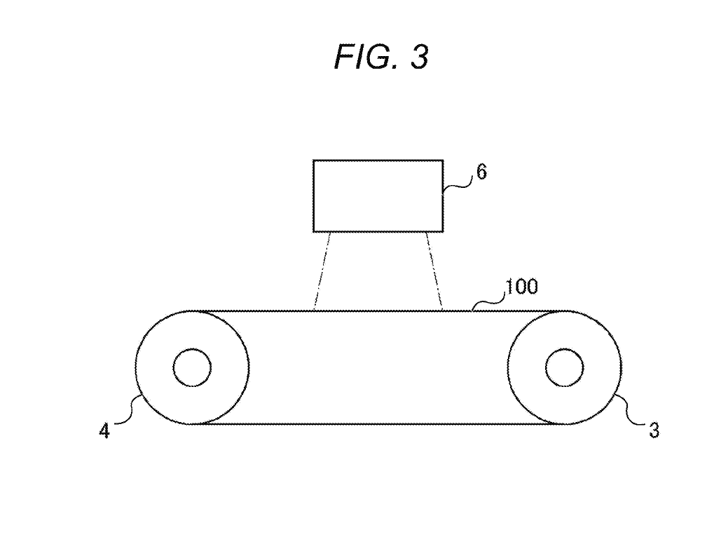

In a case where a photocurable resin is contained in the surface layer application liquid, the actinic ray irradiation device 6 illustrated in FIG. 3 emits actinic rays to photopolymerize the photocurable resin contained in the applied film.

The actinic ray irradiation device 6 is arranged at a position (above the base material 100) to irradiate the applied film on the base material 100 supported by the rollers 3 and 4.

The actinic ray irradiation device 6 irradiates an entire region in the width direction of the base material 100 with the actinic rays. The actinic rays are electromagnetic waves to optically cure the applied film, and examples thereof include ultraviolet, electron beams, or y rays. The actinic rays are preferably ultraviolet or electron beams, and ultraviolet is more preferable from the viewpoint that handling is simple and high energy can be easily obtained.

Exemplary kinds of a light source of the actinic rays include a low pressure mercury lamp, a medium pressure mercury lamp, an ultrahigh pressure mercury lamp, a carbon arc lamp, a metal halide lamp, a xenon lamp, a flash (pulse) xenon, a UV-LED. It is preferable that the actinic ray irradiation device 6 be a UV-LED irradiation device including a UV-LED as a light source from the viewpoint of suppressing heat supplied to the base material 100, suppressing degradation of bendability, and occurrence of creep of the intermediate transfer belt.

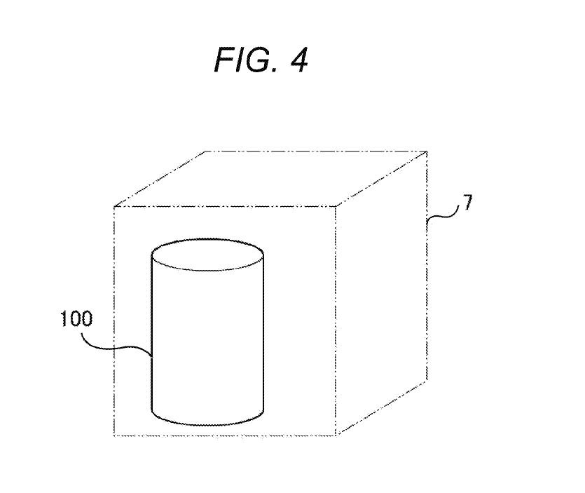

In a case where a thermosetting resin is contained in the surface layer application liquid, the drying device 7 illustrated in FIG. 4 heats the applied film in order to cure the thermosetting resin contained in the applied film.

A heating temperature in the drying device 7 is preferably within a range of 200 to 450° C. in a case where the base material 100 is a polyimide resin and a polyamide resin, and the heating temperature is preferably within a range from 30 to 60° C. in a case of a polyphenylene sulfide resin.

The purge device adjusts an oxygen concentration by supplying an inert gas such as a nitrogen gas or a rare gas to the atmosphere on the base material 100. The purge device preferably supplies the nitrogen gas and is arranged adjacent to the actinic ray irradiation device 6.

<Operation Procedure of Device>

First, the base material 100 that is the endless belt is set on the rollers 3 and 4. Specifically, the base material 100 is suspended between the two rollers 3 and 4, and the base material 100 is supported by these rollers 3 and 4.

Subsequently, the driving roller 3 is rotated by driving the rotation driving device 5, and the base material 100 suspended between the driving roller 3 and the driven roller 4 is rotationally moved between the driving roller 3 and the driven roller 4.

The base material 100 is thus rotationally moved on the endless track by rotationally driving the driving roller 3.

Next, the surface layer application liquid is applied, by using the nozzles 1 and 2, to the base material 100 that is being rotationally moved.

Specifically, the surface layer application liquid is discharged from each of the nozzles 1 and 2 to the base material 100 being rotationally moved while the two nozzles 1 and 2 are moved above the base material 100 from one end portion side to the other end portion side in the width direction Y. Since the application liquid is thus discharged to the outer peripheral surface of the base material 100 being rotationally moved while the nozzles 1 and 2 are traveling, a one spiral applied film is formed with the application liquid discharged from the one nozzle. In the present embodiment, the application liquid is discharged by using the two nozzles 1 and 2, two spiral applied films formed of the application liquid from the two nozzles are formed, and the two applied films wetly spread and become continuous with each other before being dried, and therefore, a seamless uniform applied film is formed as a result.

As described above, in the case where the applied film contains the photocurable resin, the applied film is irradiated with actinic ray rays after the applied film is formed on the entire outer peripheral surface of the base material 100 by the nozzles 1 and 2. In the case where the applied film contains the thermosetting resin, the base material 100 is brought into the drying device 7 and thermally cured.

As for irradiation with the actinic rays, specifically, since the applied film is irradiated with the actinic rays while the base material 100 is rotated, temperature increase of the base material 100 is suppressed, and the photopolymerizable monomer can be photopolymerized while suppressing change of crystallinity of the base material. The irradiation energy of the actinic rays, the number of times of irradiation, the irradiation period, and the like can be suitably set in accordance with output of a light source, a kind of photopolymerizable monomer, and the like.

It is preferable that an irradiation amount with the actinic rays be 100 mJ/cm² or more, more preferably, within a range of 120 to 200 mJ/cm², and more preferably, within a range of 150 to 180 mJ/cm² from the viewpoints of curing unevenness, hardness, a curing time, a curing rate, and the like of the applied film. The irradiation amount can be measured by, for example, UIT250 (manufactured by Ushio Inc.). As described above, it is preferable that the applied film be irradiated with ultraviolet from a UV-LED light source device from the viewpoint of reducing heat supplied to the base material.

It is preferable that the irradiation period of the actinic rays be from 0.5 seconds to 5 minutes, and more preferably, from 3 seconds to 2 minutes from the viewpoints of curing efficiency, working efficiency, and the like for the applied film.

It is preferable that an oxygen concentration in atmosphere at the time of irradiating the applied film with actinic rays be 5% or less, and more preferably, 1% or less from the viewpoints of curing unevenness and a curing time (curing efficiency) and the like of the applied film. The oxygen concentration can be adjusted by, for example, introducing a nitrogen gas into the atmosphere by a purge device. The above oxygen concentration can be measured by, for example, an atmospheric gas management oxygen concentration meter “OX 100” (manufactured by Yokogawa Electric Corporation).

As for thermal curing, specifically, the base material 100 is brought into the drying device 7, and the thermosetting resin contained in the base material is cured by heating the applied film.

### EXAMPLES

In the following, the present invention will be more specifically described by using Examples, but the present invention is not limited thereto.

<Manufacture of Intermediate Transfer Belt [1]>

(1) Heating and Kneading of Base Material

Respective following raw materials were melted and mixed by using a twin-screw kneading extruder (PMT32, manufactured by IKC Co., Ltd.) to pelletize a resin composition. A thermoplastic resin was dried at 130° C. for 8 hours before kneading, and cooled down to about 60° C. and used for kneading.

| | |
|---|---|
| Thermoplastic resin material: polyphenylene sulfide | 100 parts by mass |
| (E2180 manufactured by Toray Industries, Inc.) | |
| (crystallinity, melting point 280° C., glass | |
| transition point 90° C.) | |
| Stabilizer: phenolic antioxidant (ADK STAB AO-50 | 5 parts by mass |
| manufactured by ADEKA) | |
| Conductive filler: acetylene black (HS-100 | 16 parts by mass |
| manufactured by Denka) | |
| Lubricant: Calcium montanate (Ceridust 5551 | 0.2 parts by mass |
| manufactured by Clariant Japan KK) | |

(2) Preparation of Base Material Belt

The pellets were dried at 130° C. for 8 hours, and cooled and solidified by a 40 mm-diameter extruder by making the dried pellets contact an outer surface of a cooling mandrel. The extruder is equipped with a 6-spiral annular die having a diameter of 150 mm and a lip width of 1 mm, and the cooling mandrel is attached via a support rod on an axis same as the annular die and has an outer diameter of 140 mm. While the seamless belt is pulled in a state of being kept in a cylindrical shape by a core set inside the formed seamless belt and a roll set outside, the belt is cut in a cross-sectional slice having a length of 290 mm, thereby manufacturing a base material belt.

(3) Preparation of Application Liquid [1] for Surface Layer Formation

| | |
|---|---|
| Multifunctional (meth)acrylate: dipentaerythritol | 85 parts by mass |
| hexaacrylate “DPHA” (manufactured by Nippon | |
| Kayaku Co., Ltd.) | |
| Polymerizable component having low surface energy | 10 parts by mass |
| group: “Megaface” (manufactured by DIC | |
| Corporation) | |

| | | |
|---|---|---|
| Metal oxide fine particles: | surface treated tin oxide | 5 parts by mass |

The metal oxide fine particles (surface treated tin oxide) were prepared by applying coupling treatment to the tin oxide with 5 parts by mass of silane coupling agent KBM-503 (manufactured by Shin-Etsu Chemical Co., Ltd.) with respect to 100 parts by mass of tin oxide (manufactured by CIK Nanotech).

The application liquid for surface layer formation [1] was prepared by dissolving and dispersing the above respective raw materials in methyl isobutyl ketone (MIBK) as a solvent such that a viscosity of the application liquid became 1 mPa·s. The viscosity of the application liquid was measured with a viscometer (manufactured by EKO Instruments Co., Ltd.) at a liquid temperature of 20° C.

(4) Surface Layer Formation

While the base material is held and rotated by a biaxial roller, an applied film was formed by applying the application liquid for surface layer formation [1] from two nozzles under following application conditions such that a dried film thickness became 4 μm. The applied film was dried by generating heat from the inside of the biaxial roller, and a surface layer was formed by curing the applied film by irradiating the applied film with ultraviolet as actinic rays, thereby obtaining an intermediate transfer belt [1]. The ultraviolet was irradiated while a light source was fixed and the base material on which the applied film was formed on the outer peripheral surface of the base material was rotated at a rotation speed of 10 mm/sec.

(Application Conditions)

Nozzle travel speed: 9.0 mm/sec

Rotation speed of base material belt during application of application liquid: 1000 mm/sec

Nozzle inner diameter (m): 0.2 mm

Nozzle outer diameter 1 mm

Number of nozzles: 2

Nozzle inner diameter (m)/center-to-center distance between nozzles (L): 0.07

Nozzle flow rate: 4.5 ml/min (flow rate per nozzle)

Viscosity of application liquid (20° C.): 1 mPa·s

(Ultraviolet Irradiation Conditions)

Type of light source: UV-LED lamp “UV-SPV series” (manufactured by Revox Inc.)

Wavelength of light source: 365 nm

Distance from irradiation port to surface of applied film: 40 mm

Irradiation amount: 100 mw/cm²

Irradiation period (period during which base material is rotated): 150 seconds

<Manufacture of Intermediate Transfer Belts (2) to (8)>

Intermediate transfer belts [2] to [8] were obtained in a manner similar to manufacture for the intermediate transfer belt [1] except for respectively changing, as shown in Table I, the viscosity of application liquid for surface layer formation, the number of nozzles, the nozzle inner diameter (m)/center-to-center distance between nozzles (L), the surface layer thickness, the flow rate per nozzle in manufacture for the intermediate transfer belt [1]; and changing application conditions as specified below.

<<Manufacture of Intermediate Transfer Belt [2]>>

(Application Conditions)

Nozzle travel speed: 13.5 mm/sec

Rotation speed of base material belt during application of application liquid: 1200 mm/sec

Nozzle inner diameter (m): 0.2 mm

Nozzle outer diameter 1 mm

Number of nozzles: 3

Nozzle inner diameter (m)/center-to-center distance between nozzles (L): 0.05

Nozzle flow rate: 4.5 ml/min (flow rate per nozzle)

Viscosity of application liquid (20° C.): 5 mPa·s

<<Manufacture of Intermediate Transfer Belt [3]>>

(Application Conditions)

Nozzle travel speed: 22.5 mm/sec

Rotation speed of the base material belt during application of application liquid: 1400 mm/sec

Nozzle inner diameter (m): 0.4 mm

Nozzle outer diameter 1.2 mm

Number of nozzles: 5

Nozzle inner diameter (m)/center-to-center distance between nozzles (L): 0.07

Nozzle flow rate: 4.5 ml/min (flow rate per nozzle)

Viscosity of application liquid (20° C.): 10 mPa·s

<<Manufacture of Intermediate Transfer Belt [4]>>

(Application Conditions)

Nozzle travel speed: 22.5 mm/sec

Rotation speed of the base material belt during application of application liquid: 1400 mm/sec

Nozzle inner diameter (m): 0.2 mm

Nozzle outer diameter 1.0 mm

Number of nozzles: 5

Nozzle inner diameter (m)/center-to-center distance between nozzles (L): 0.08

Nozzle flow rate: 2.3 ml/min (flow rate per nozzle)

Viscosity of application liquid (20° C.): 1 mPa·s

<<Manufacture of Intermediate Transfer Belt [5]>>

(Application Conditions)

Nozzle travel speed: 9 mm/sec

Rotation speed of base material belt during application of application liquid: 1200 mm/sec

Nozzle inner diameter (m): 0.2 mm

Nozzle outer diameter 1.0 mm

Number of nozzles: 2Nozzle inner diameter (m)/center-to-center distance between nozzles (L): 0.05

Nozzle flow rate: 3.2 ml/min (flow rate per nozzle)

Viscosity of application liquid (20° C.): 3 mPa·s

<<Manufacture of Intermediate Transfer Belt [6]>>

(Application Conditions)

Nozzle travel speed: 9 mm/sec

Rotation speed of the base material belt during application of application liquid: 800 mm/sec

Nozzle inner diameter (m): 0.4 mm

Nozzle outer diameter 1.2 mm

Number of nozzles: 2

Nozzle inner diameter (m)/center-to-center distance between nozzles (L): 0.07

Nozzle flow rate: 9.0 ml/min (flow rate per nozzle)

Viscosity of application liquid (20° C.): 5 mPa·s

<<Manufacture of Intermediate Transfer Belt [7]>>

(Application Conditions)

Nozzle travel speed: 9 mm/sec

Rotation speed of base material belt during application of application liquid: 1000 mm/sec

Nozzle inner diameter (m): 0.4 mm

Nozzle outer diameter 1.2 mm

Number of nozzles: 2

Nozzle inner diameter (m)/center-to-center distance between nozzles (L): 0.03

Nozzle flow rate: 4.5 ml/min (flow rate per nozzle)

Viscosity of application liquid (20° C.): 15 mPa·s

<<Manufacture of Intermediate Transfer Belt [8]>>

(Application Conditions)

Nozzle travel speed: 9 mm/sec

Rotation speed of the base material belt during application of application liquid: 800 mm/sec

Nozzle inner diameter (m): 0.4 mm

Nozzle outer diameter 1.2 mm

Number of nozzles: 2

Nozzle inner diameter (m)/center-to-center distance between nozzles (L): 0.12

Nozzle flow rate: 11.3 ml/min (flow rate per nozzle)

Viscosity of application liquid (20° C.): 10 mPa·s

<Manufacturing Intermediate Transfer Belts (9) to (18)>

The intermediate transfer belts [9] to [18] were obtained in a manner similar to manufacture for the intermediate transfer belt [1] except for respectively changing, as shown in Table I below, the viscosity of application liquid for surface layer formation, the number of nozzles, the nozzle inner diameter (m)/center-to-center distance between nozzles (L), the surface layer thickness, the flow rate per nozzle in manufacture for the intermediate transfer belt [1]; and changing application conditions as specified below.

(Application Conditions)

Nozzle travel speed: 9.0 mm/sec

Rotation speed of base material belt: 1000 mm/sec

Nozzle inner diameter (m): 0.2 to 0.4 mm

Nozzle outer diameter 1.0 to 1.2 mm

[Evaluation]

<Film Thickness Deviation>

As for measurement of a film thickness of the surface layer of each intermediate transfer belt, arbitrary fourteen points were measured in a range of 25 mm in the axial direction (width direction) by using MV-3250 manufactured by JASCO Corporation. Among such measured values, a film thickness deviation k was calculated for a minimum value t_{A} and a maximum value t_{B} on the basis of following Expression, and the film thickness deviation k was evaluated on the basis of following criteria.

Film thickness deviation k (μm)=t_{B}−t_{A}

(Evaluation Criteria)

⊙: Less than 0.4 μm

◯: 0.4 μm or more and less than 0.7 μm

Δ: 0.7 μm or more and less than 1.0 μm

x: 1.0 μm or more

<Cleaning Property of Intermediate Transfer Belt>

The intermediate transfer belt manufactured as described above was mounted on a commercially available color multifunctional machine “bizhub PRESS (registered trademark) C6000 (manufactured by Konica Minolta Co., Ltd.)” as an image forming device, and an image in which a printing ratio of each of colors YMCK is 2.5% was printed on a one million pieces of neutral paper of A4 size. Subsequently, a halftone image was printed on each of three pieces of the neutral paper, and the halftone images in the three pieces were visually observed and evaluation was made on following criteria.

### (Evaluation Criteria)

◯: No cleaning failure (having no defect such as streaks on image)

x: Cleaning failure (having defect such as streaks on image)

TABLE 1

| | | Nozzle diameter | | | | | | |
|---|---|---|---|---|---|---|---|---|
| Intermediate | | (m)/center-to-center | Surface layer | | Nozzle | | | |
| transfer | No. of | distance between | thickness | Viscosity | flow rate | Film thickness | Cleaning | |
| belt No. | nozzles | nozzles (L) | [μm] | [mPa · s] | [mL/min] | deviation | property | Remarks |
| 1 | 2 | 0.07 | 4 | 1 | 4.5 | ⊙ | ◯ | Present invention |
| 2 | 3 | 0.05 | 4 | 5 | 4.5 | ⊙ | ◯ | Present invention |
| 3 | 5 | 0.07 | 4 | 10 | 4.5 | ◯ | ◯ | Present invention |
| 4 | 5 | 0.08 | 2 | 1 | 2.3 | ◯ | ◯ | Present invention |
| 5 | 2 | 0.05 | 3 | 3 | 3.2 | ⊙ | ◯ | Present invention |
| 6 | 2 | 0.07 | 8 | 5 | 9.0 | ◯ | ◯ | Present invention |
| 7 | 2 | 0.03 | 4 | 15 | 4.5 | X | X | Comparative example |
| 8 | 2 | 0.12 | 10 | 10 | 11.3 | Δ | X | Comparative example |
| 9 | 2 | 0.05 | 4 | 1 | 4.5 | ⊙ | ◯ | Present invention |
| 10 | 2 | 0.03 | 4 | 1 | 4.5 | Δ | X | Comparative example |
| 11 | 2 | 0.12 | 4 | 1 | 4.5 | X | X | Comparative example |
| 12 | 2 | 0.07 | 4 | 3 | 4.5 | ⊙ | ◯ | Present invention |
| 13 | 2 | 0.07 | 4 | 5 | 4.5 | ⊙ | ◯ | Present invention |
| 14 | 2 | 0.07 | 4 | 10 | 4.5 | ◯ | ◯ | Present invention |
| 15 | 2 | 0.07 | 4 | 15 | 4.5 | X | X | Comparative example |
| 16 | 2 | 0.07 | 4 | 5 | 2.5 | X | X | Comparative example |
| 17 | 2 | 0.07 | 4 | 5 | 6.5 | ◯ | ◯ | Present invention |
| 18 | 2 | 0.07 | 4 | 5 | 11.0 | X | X | Comparative example |

According to the results illustrated in Table I, it can be grasped that the intermediate transfer belt manufactured by the manufacturing method for an intermediate transfer belt according to the present invention has a uniform surface layer and a favorable cleaning property can be ensured.

Although embodiments of the present invention have been described and illustrated in detail, the disclosed embodiments are made for purposes of illustration and example only and not limitation. The scope of the present invention should be interpreted by terms of the appended claims.

What is claimed is:

1. A manufacturing method for an intermediate transfer belt to manufacture an intermediate transfer belt including at least a base material and a surface layer, comprising:
forming a surface layer by applying application liquid to an outer peripheral surface of the base material by using a plurality of nozzles while the base material is being rotated, the application liquid having a viscosity within a range of 0.5 to 10 mPa·s at 20° C.,
wherein, as for the nozzles used in the forming, a flow rate per nozzle is set within a range of 3 to 10 mL/min, and a ratio value (m/L) between a nozzle inner diameter (m) and a center-to-center distance between nozzles (L) is set in a range of 0.05 to 0.10.

2. The manufacturing method for an intermediate transfer belt according to claim 1, wherein the surface layer is formed on an outer peripheral surface of the base material by using the plurality of nozzles while the base material is held and rotated by a plurality of rollers.

3. The manufacturing method for an intermediate transfer belt according to claim 1, wherein the surface layer has a thickness within a range of 2.0 to 8.0 μm.

4. The manufacturing method for an intermediate transfer belt according to claim 1, wherein the surface layer contains a photocurable resin.

5. The manufacturing method for an intermediate transfer belt according to claim 1, wherein the surface layer contains a thermosetting resin.

6. The manufacturing method for an intermediate transfer belt according to claim 1, wherein the base material is a polyphenylene sulfide resin, a polyimide resin, or a polyamideimide resin.

7. A manufacturing device for an intermediate transfer belt to manufacture an intermediate transfer belt including at least a base material and a surface layer, comprising:
a plurality of rollers that holds and rotates the base material; and
a plurality of nozzles that forms the surface layer by applying, to an outer peripheral surface of the base material, application liquid having a viscosity within a range of 0.5 to 10 mPa·s at 20° C.,
wherein a flow rate per nozzle is set within a range of 3 to 10 mL/min, and a ratio value (m/L) between a nozzle inner diameter (m) and a center-to-center distance between nozzles (L) is set in a range of 0.05 to 0.10.
